(19) United States
(12) Patent Application Publication
(10) Pub. No.: US 2007/0027604 A1
(43) Pub. Date: Feb. 1, 2007

(54) Condition-based soft-stop function for motor vehicle braking systems

(76) Inventors: Silvia Tobajas Cuevas, Stuttgart (DE); Simon Schilling, Abstatt (DE)

Correspondence Address: KENYON & KENYON LLP, ONE BROADWAY, NEW YORK, NY, 10004, US

(21) Appl. No.: 11/476,395

(22) Filed: Jun. 27, 2006

(30) Foreign Application Priority Data
Jun. 27, 2005 (DE) 10 2005 029 891.5

(51) Int. Cl. G06G 7/76

(52) U.S. Cl. 701/70

(57) ABSTRACT

A braking system in particular for motor vehicles, having a soft-stop function, including at least one wheel brake and a control unit which, during deceleration, executes the soft-stop function and which, for this purpose, actuates a braking force reducer which partially reduces the braking force acting on the wheel brake in order to reduce the jerky braking movement. The vehicle may also be safely decelerated in extreme operating conditions when the soft-stop function is implemented in such a way that the extent of the braking force reduction is a function of the uphill grade of the roadway, the brake temperature and/or the amount of wear of the wheel brake.

### FIELD OF THE INVENTION

The present invention relates to a control unit having a soft-stop function for a motor vehicle braking system equipped with such a control unit.

### BACKGROUND INFORMATION

During a deceleration operation of a motor vehicle in which the driver actuates the service brake, a friction coefficient transfer occurs at the wheel brake shortly before the vehicle comes to a standstill (transfer from sliding friction to static friction). This results in suddenly greater deceleration which is noticeable as what is known as jerky braking movement.

It is known from the related art to reduce this jerky braking movement by using a specific function generally known as a soft-stop function (SST). As a rule, the function is stored in the form of software in a control unit of the braking system. During deceleration, the function automatically reduces the braking pressure acting on the wheel brake when the vehicle falls below a predefined velocity and subsequently holds the pressure at a predefined level. A braking force reducer, such as valves situated in the brake line, is automatically actuated in order to reduce the braking pressure.

Under normal driving conditions, known soft-stop functions operate adequately well. However, in certain borderline situations, such as a steep uphill grade in the roadway, overheated brakes, or heavily worn brake linings, the residual braking pressure remaining after the automatic pressure reduction may be too low to hold the vehicle or too low to brake the vehicle quickly enough. The vehicle is thus unable to come to a stop on a steep downhill grade or at least the braking distance is extended.

### SUMMARY OF THE INVENTION

The object of the present invention is to improve the effectiveness of the soft-stop function in borderline situations.

A main idea of the present invention is to design the soft-stop function in such a way that it is only activated on a reduced scale or not at all as a function of the uphill grade of the roadway, the temperature of the wheel brake, and/or the amount of wear of the wheel brake. The soft-stop function is preferably completely deactivated when at least one of the above-mentioned parameters exceeds a predefined threshold value, thereby ensuring that also in borderline situations the vehicle is braked to a standstill and does not unintentionally continue to roll.

According to a first embodiment of the present invention, the soft-stop function is deactivated when the uphill grade or the downhill grade of the roadway is steeper than 20%, in particular steeper than 25%.

According to a second embodiment of the present invention, the soft-stop function is deactivated when the brake temperature is higher than 400° C., in particular higher than 500° C.

According to a third embodiment of the present invention, the soft-stop function is deactivated when the brake wear indicator signals a critical amount of wear.

In the event of the function being activated on a reduced scale, the rate of the automatic braking force reduction or the residual braking force is preferably dependent on the driving condition (the uphill grade in particular) or the vehicle's operating condition (the brake temperature and the brake wear in particular).

### BRIEF DESCRIPTION OF THE DRAWINGS

FIG. 1 shows a schematic view of a motor vehicle braking system having a soft-stop function.

FIG. 2 shows the curve of a status variable of the soft-stop function as a function of the uphill grade.

FIG. 3 shows the curve of a status variable of the soft-stop function as a function of the brake temperature.

FIG. 4 shows the curve of a status variable of the soft-stop function as a function of the amount of wear of the wheel brakes.

FIG. 5 shows the extent of the braking force reduction as a function of the uphill grade of the roadway, the brake temperature, or the amount of wear of the wheel brakes.

### DETAILED DESCRIPTION

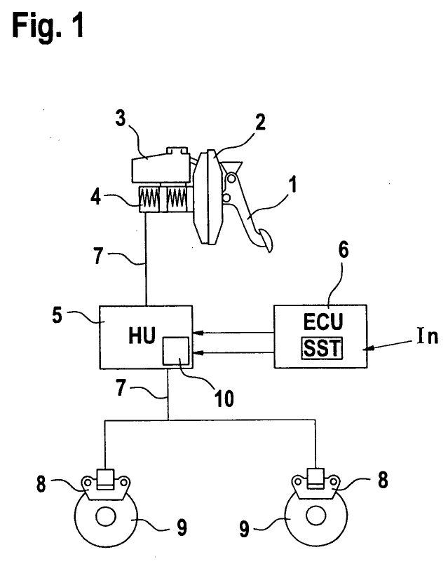

FIG. 1 shows a schematic representation of a hydraulic vehicle braking system having a soft-stop function SST which is stored in the form of software in a control unit 6. The braking system essentially includes a brake pedal 1, a brake booster 2, a brake master cylinder 4, and a brake fluid reservoir 3 which is situated on brake master cylinder 4. When the brake pedal is actuated, pressure builds up in brake pipes 7 which presses brake calipers 8 against brake discs 9 of the wheel brakes.

Moreover, the braking system includes a hydraulic unit 5 with a hydraulic pump (not shown) situated therein via which brake pressure may be built up automatically in extreme driving situations in order to carry out a stability function (e.g., ESP). Control unit 6 is additionally connected to a braking force reducer 10 via which the soft-stop function SST is carried out. Braking force reducer 10 is preferably part of hydraulic unit 5.

During deceleration, when the vehicle falls below a predefined velocity, the brake pressure acting on wheel brakes 8, 9 is reduced by a predefined value, e.g., by opening valves in braking force reducer 10, so that the jerky braking movement is reduced. (The trigger threshold for the soft-stop function may also be dependent on the deceleration of the vehicle.)

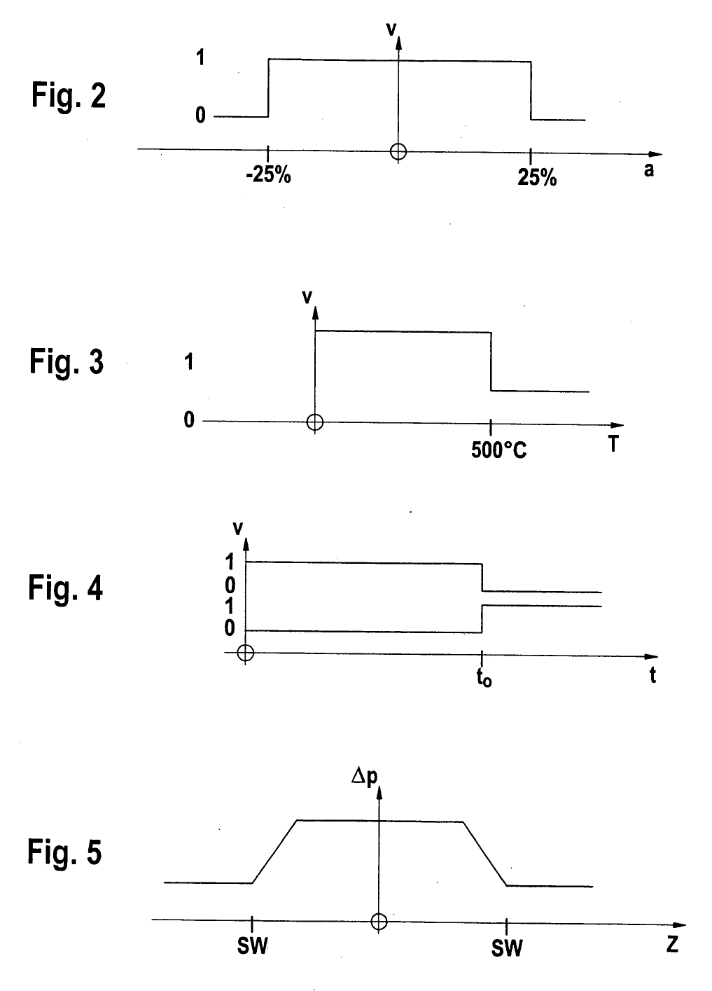

The soft-stop function is designed in this exemplary embodiment in such a way that the function is only active within predefined boundaries with regard to the driving or braking condition. The soft-stop function is preferably deactivated outside of these boundaries. The status of soft-stop function SST as a function of the uphill grade of the roadway, the brake temperature, and the amount of wear of wheel brakes 8, 9 is shown as an example in FIGS. 2 through 4.

FIG. 2 shows the curve of a variable V which represents the status of soft-stop function SST (active/inactive) as a function of the uphill grade of the roadway. In the present example, soft-stop function SST is activatable (signal level=1) as long as the uphill grade or the downhill grade is not steeper than 25%. In the event of a steeper uphill grade or a steeper downhill grade, soft-stop function SST is switched to inactive (signal level=0). The uphill grade of the roadway may be measured, for example, using a slope angle sensor or it may be estimated using a longitudinal acceleration sensor, for example.

FIG. 3 shows the curve of an SST status variable V which indicates the status of soft-stop function SST (active/inactive) as a function of the brake temperature. Soft-stop function SST is activatable in this case when the brake temperature is lower than 500° C. If the brake temperature exceeds 500° C., soft-stop function SST is deactivated. This prevents the vehicle's braking performance from becoming too poor or prevents the vehicle from unintentionally continuing to roll. The brake temperature may be estimated using a brake temperature model, for example.

FIG. 4 shows the curve of an SST variable V which indicates the status of soft-stop function SST (active/inactive) as a function of the amount of wear of the wheel brakes. In this case, the vehicle includes a wear dot known from the related art which indicates a critical brake condition to the driver. A wear dot is an electrical contact situated in a brake lining which is exposed at a certain amount of wear of the wheel brake, thereby closing an electrical circuit. The soft-stop function is deactivated when the wear dot has contact. The amount of wear of the wheel brake may optionally also be calculated via a wear model.

FIG. 5 shows the curve of the braking force reduction in a soft-stop function SST according to another embodiment of the present invention. Soft-stop function SST differentiates in this case not only between the status “active” and the status “inactive” but is implemented in such a way that the extent of braking force reduction Δp is a constant function of the driving condition or the brake condition. As is apparent in FIG. 5, the extent of the braking force reduction within a certain range is linearly dependent on the reference variable. In the case of an uphill grade, braking force reduction Δp is reduced with an increasing uphill grade of the roadway. In the case of a slight uphill grade of the roadway, the extent of braking force reduction Δp is maximal and subsequently decreases linearly in a predefined uphill grade range. Soft-stop function SST remains completely deactivated when a predefined threshold value SW is exceeded. This applies accordingly with regard to the other status variables.

### LIST OF REFERENCE NUMERALS

1 brake pedal

2 brake booster

3 brake fluid reservoir

4 brake master cylinder

5 hydraulic unit

6 control unit

7 brake pipes

8 brake calipers

9 brake discs

10 braking force reducer

SST soft-stop function

What is claimed is:

1. A control unit, comprising:
an arrangement for storing a soft-stop function; and
an arrangement for, during deceleration, automatically actuating a braking force reducer to at least partially reduce a braking force acting on a wheel brake, in order to reduce a jerky braking movement, wherein:
an extent of the braking force reduction is a function of at least one of an uphill grade of a roadway, a temperature of the wheel brake, and an amount of wear of the wheel brake.

2. The control unit as recited in claim 1, wherein the soft-stop function is deactivated when the uphill grade of the roadway exceeds a predefined threshold value.

3. The control unit as recited in claim 2, wherein the soft-stop function is deactivated when the uphill grade of the roadway is steeper than 20%.

4. The control unit as recited in claim 1, wherein the soft-stop function is deactivated when the temperature of the wheel brake exceeds a predefined threshold value.

5. The control unit as recited in claim 4, wherein the soft-stop function is deactivated when the temperature of the wheel brake is higher than 400° C.

6. The control unit as recited in claim 1, wherein the soft-stop function is deactivated when the amount of wear of the wheel brake exceeds a predefined threshold value.

7. The control unit as recited in claim 1, wherein the soft-stop function is deactivated when a brake wear indicator indicates a critical amount of wear.

8. A braking system for performing a soft-stop function, comprising:
at least one wheel brake;
a braking force reducer; and
a control unit for storing the soft-stop function, wherein:
during deceleration, automatically actuating a braking force reducer to at least partially reduce a braking force acting on a wheel brake, in order to reduce a jerky braking movement, and
an extent of the braking force reduction is a function of at least one of an uphill grade of a roadway, a temperature of the wheel brake, and an amount of wear of the wheel brake.

9. A method for executing a soft-stop function during deceleration of a vehicle, comprising:
causing a control unit storing the soft-stop function as software to at least partially reducing a braking force acting on a wheel brake by automatically actuating a braking force reducer in order to reduce a jerky braking movement, wherein:
an extent of the braking force reduction is a function of at least one of an uphill grade of a roadway, a temperature of the wheel brake, and an amount of wear of the wheel brake.

10. The method as recited in claim 9, further comprising:
deactivating the soft-stop function when at least one of the uphill grade of the roadway, the temperature of the wheel brake, and the amount of wear of the wheel brake exceeds a predefined threshold value.

11. The control unit as recited in claim 1, wherein the control unit is for a motor vehicle braking system.

12. The control unit as recited in claim 2, wherein the soft-stop function is deactivated when the uphill grade of the roadway is steeper than 25%.

13. The control unit as recited in claim 4, wherein the soft-stop function is deactivated when the temperature of the wheel brake is higher than 500° C.
